(19) United States
(12) Patent Application Publication
(10) Pub. No.: US 2021/0342805 A1
(43) Pub. Date: Nov. 4, 2021

(54) SYSTEM AND METHOD FOR IDENTIFYING GRAB-AND-GO TRANSACTIONS IN A CASHIERLESS STORE

(71) Applicant: Kooick Inc., New York, NY (US)

(72) Inventors: Davi Geiger, Old Greenwich, CT (US); Carlos Henrique Cavalcanti Corrêa, Rio de Janeiro (BR)

(21) Appl. No.: 17/246,757

(22) Filed: May 3, 2021

Related U.S. Application Data
(60) Provisional application No. 63/018,948, filed on May 1, 2020.

(51) Int. Cl. G06Q 20/20; G06N 7/00; G06N 20/00; H04N 7/18; G06K 9/00; H04N 5/247; G01G 19/414

(52) U.S. Cl. CPC G06Q 20/203; G06Q 20/208; G06N 7/005; G06N 20/00; G06Q 20/3276; G06K 9/00771; H04N 5/247; G01G 19/4144; H04N 7/188

(57) ABSTRACT

A method and system for detecting a commercial transaction through physical interactions with items, the method comprising receiving data from a plurality of sensory modules associated with one or more shelves within a container, the plurality of sensory modules including a static cameras module, a weight sensors module, and a video cameras module, wherein the data includes physical activities corresponding to items on the smart shelves in a given session. The method further comprises resolving the data from the sensory modules using probabilistic reasoning and machine learning, determining a new container state after the given session based on the resolved data, and determining a final commercial transaction based on the new container state.

### CROSS REFERENCE TO RELATED APPLICATION

This application claims the priority of U.S. Provisional Application No. 63/018,948, entitled “SYSTEM AND METHOD FOR IDENTIFYING GRAB-AND-GO TRANSACTIONS IN A CASHIERLESS STORE,” filed on May 1, 2020, the disclosure of which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

### Field of the Invention

This application generally relates to cashierless transactions, and in particular, tracking physical activities and states of items or shelves in a commercial environment to determine purchases.

### Description of the Related Art

The existence of commercial refrigerators and cabinets is abundant; millions of them exist in different formats and at different types of commercial places. For example, it is common to find in pharmacies closed cabinets with razors, electric tooth brushes, and other products. Also in pharmacies, one may find refrigerators with beverages. Typically today, users may take items from such refrigerators and/or cabinets and pay for these items at a cashier.

### SUMMARY OF THE INVENTION

The present invention provides a system, method, and non-transitory computer-readable media for detecting a commercial transaction through physical interactions with items. According to one embodiment, the system comprises a plurality of sensory modules associated with one or more shelves within a container, wherein the plurality of sensory modules including a static cameras module, a weight sensors module, and a video cameras module. The system further comprises an integration module configured to receive data from the plurality of sensory modules, wherein the data includes physical activities corresponding to items on the smart shelves in a given session, resolve the data from the sensory modules using probabilistic reasoning and machine learning, determine a new container state after the given session based on the resolved data, and determine a final commercial transaction based on the new container state.

The static cameras module may be configured to retrieve images of inside the container before the given session and images of inside the container after the given session, determine state configurations of the one or more smart shelves, and transmit the state configurations to the integration module. The video cameras module may be configured to receive video recordings that start when the container is opened and ends when the container is closed, determine items that have been placed in and out of the container and times of which the items have been placed in and out of the container, and transmit associated with the determined items and times to the integration module. The weight sensors module may be configured to detect weight changes on the one or more shelves during the given session. The integration module may be further configured to resolve the static camera module detecting an item removal by confirming with data from the video cameras module and the weight sensors module.

According to one embodiment, the method comprises receiving data from a plurality of sensory modules associated with one or more shelves within a container, the plurality of sensory modules including a static cameras module, a weight sensors module, and a video cameras module, wherein the data includes physical activities corresponding to items on the smart shelves in a given session. The method further comprises resolving the data from the sensory modules using probabilistic reasoning and machine learning, determining a new container state after the given session based on the resolved data, and determining a final commercial transaction based on the new container state.

The method may further comprise detecting a change to a current container state has occurred. The current container state may comprise data identifying available inventory and placement of the inventory in the container prior to the detected change to the current container state. Determining the new container state may further comprise determining the new container state based a change to the available inventory or placement of the inventory. The final commercial transaction may comprise data including a description of which items have been taken from the container and an indication that the taken items are desired to be purchased.

According to one embodiment, the computer-readable media comprises computer program code for receiving data from a plurality of sensory modules associated with one or more shelves within a container, the plurality of sensory modules including a static cameras module, a weight sensors module, and a video cameras module, wherein the data includes physical activities corresponding to items on the smart shelves in a given session. The computer-readable media further comprises computer program code for resolving the data from the sensory modules using probabilistic reasoning and machine learning, computer program code for determining a new container state after the given session based on the resolved data, and computer program code for determining a final commercial transaction based on the new container state.

The non-transitory computer-readable media may further comprise computer program code for detecting a change to a current container state has occurred. The current container state may comprise data identifying available inventory and placement of the inventory in the container prior to the detected change to the current container state. The computer program code for determining the new container state may further comprise computer program code for determining the new container state based a change to the available inventory or placement of the inventory. The final commercial transaction may comprise data including a description of which items have been taken from the container and an indication that the taken items are desired to be purchased.

### BRIEF DESCRIPTION OF THE DRAWINGS

The invention is illustrated in the figures of the accompanying drawings which are meant to be exemplary and not limiting, in which like references are intended to refer to like or corresponding parts.

FIG. 1 illustrates an exemplary process of an automatic check out in a grab-and-go environment according to an embodiment of the present invention.

FIG. 2 illustrates a computing system according to an embodiment of the present invention.

FIGS. 3A, 3B, 3C, 4A, 4B, and 4C illustrate a smart shelf system according to an embodiment of the present invention.

FIG. 5 illustrates a data flow diagram of a module system according to an embodiment of the present invention.

FIG. 6 illustrates a flowchart of a method for detecting a commercial transaction according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

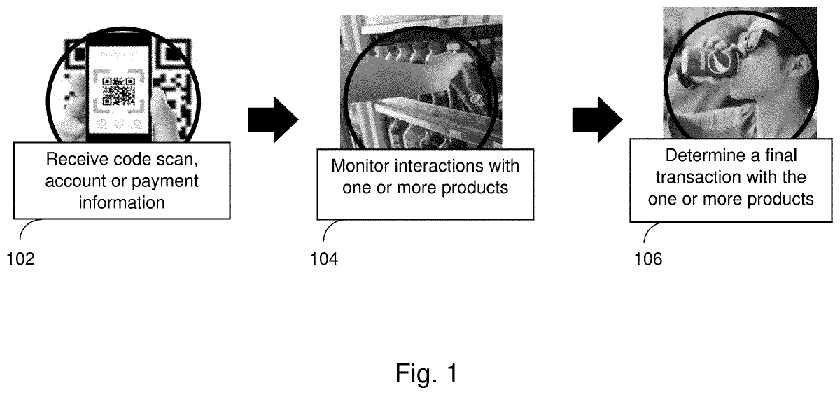

The present application discloses a system and method for processing grab-and-go activities. According to one embodiment, the disclosed system may identify merchandise a user has taken from a storage or display of objects (such as, refrigerators and/or cabinets within a commercial environment) and determine intent of the user corresponding to the merchandise, e.g., a commercial transaction or a purchase. FIG. 1 presents an exemplary process of an automatic checkout in a grab-and-go environment according to an embodiment of the present invention. Users may scan (e.g., via quick response (“QR”) code), swipe, or input account information and/or a method of payment at a store, step 102. The users may be monitored for interactions with various items or merchandise within the store, step 104. The items or merchandise may be stored or placed within, for example, refrigerators where the users may open a door and take an item.

According to embodiments of the present invention, a system may automatically determine that certain ones of the interactions are finalized transactions that allow the users to purchase the items or merchandise and skip checkout lines or cashier systems, step 106. The disclosed system may include smart shelves and through different sensors, use of machine learning, computer vision, probabilistic reasoning, and artificial intelligence, can generate a final commercial transaction as well as a container state based on information from the smart shelves. The final commercial transaction may include a description of which merchandise items have been taken from the container by a user from the container during a session and an indication that the merchandise items are in the process of being purchased. A session may begin when the user opens a door of a container that includes the smart shelves and end when the door is closed. A container state may include a description of all merchandise items inside the container at any given time. The system may also determine that during a session, a user can manipulate the merchandise items and return them to possibly different shelves. A first container state at the start of a session and a second container state at the end of a session may be used by the system to determine the final commercial transaction.

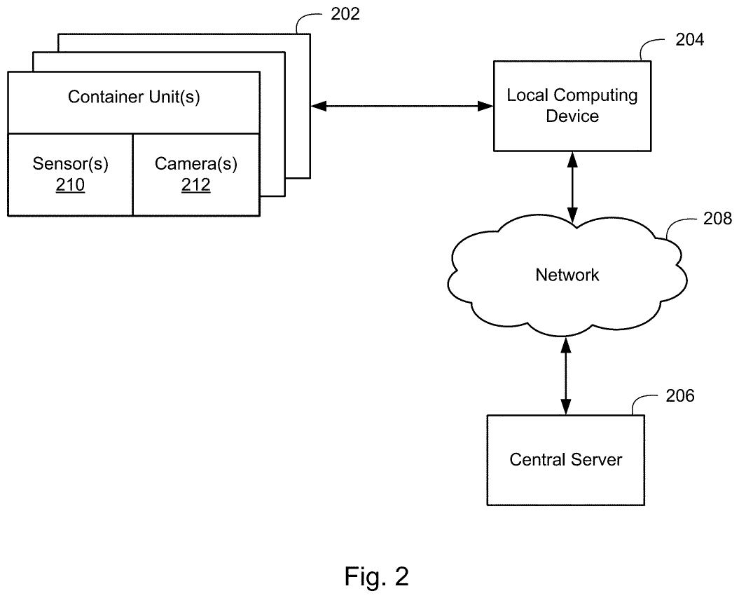

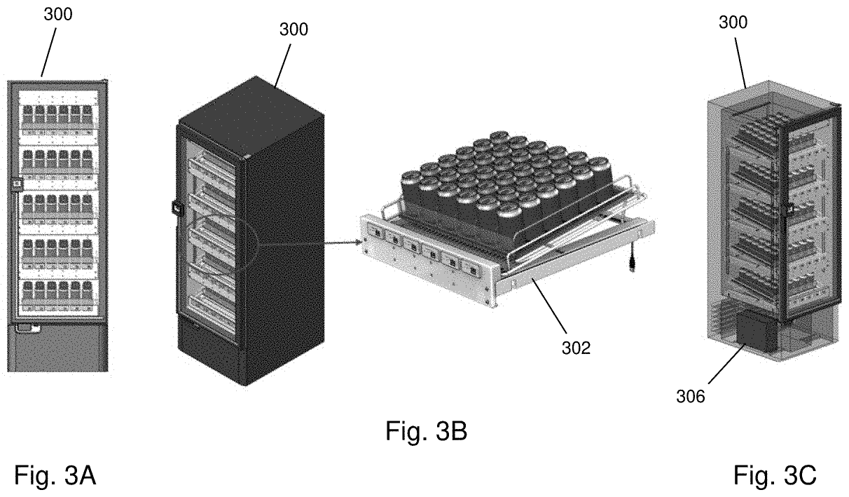

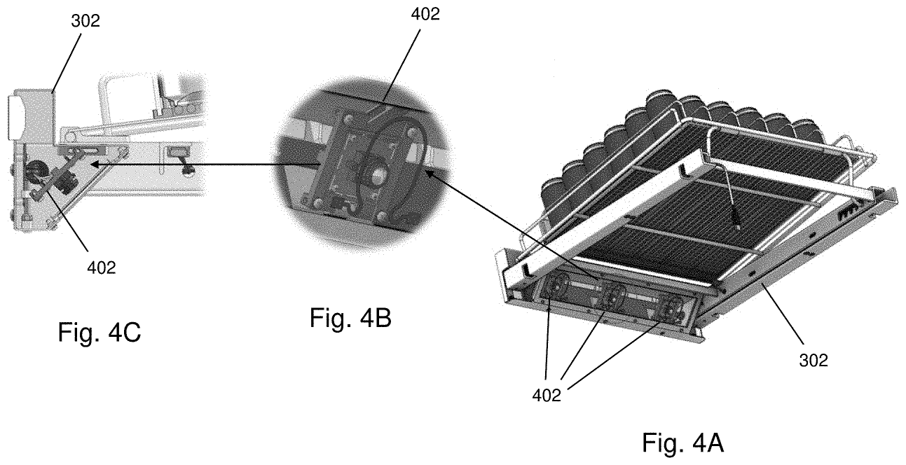

FIG. 2 presents a computing system according to an embodiment of the present invention. The system presented in FIG. 2 includes container unit(s) 202, local computing device 204, central server 206, and network 208. Container unit(s) 202 may comprise one or more of shelves, racks, cases, cabinets, bins, floor locations, or other suitable storage mechanisms for holding, supporting, or storing merchandise. In one embodiment, the container unit(s) 202 include smart shelves which are described in further detail with respect to the description of FIGS. 3A through 4C. The container unit(s) 202 include sensor(s) 210 and camera(s) 212. Sensor(s) 210 may include, but are not limited to, weight sensors, radio frequency (RF) receivers, temperature sensors, humidity sensors, vibration sensors, and so forth. The sensor(s) 210 may be configured to acquire information on the container unit(s) 202. Cameras 212 may comprise optical sensors, cameras, or three-dimensional (3D) sensors, configured to acquire images of picking or placement of merchandise items on the container unit(s) 202.

During operation of the container unit(s) 202, the sensor(s) 210 and camera(s) 212 may be configured to gather information suitable for tracking the location of merchandise items within the container unit(s) 202 and their movement. The gathered information may be transmitted to local computing device 204 which conducts machine learning, computer vision, probabilistic reasoning, and/or artificial intelligence processes on the gathered information to perform item recognition and transaction processing related to the merchandise items on the container unit(s) 202. For example, a series of images acquired by the camera(s) 212 may indicate removal of an item 104 from a particular container unit(s) 202 by a user. In another example, sensor data from the sensor(s) 210 may be used to determine a quantity on hand at a particular container unit(s) 202, change in quantity of merchandise items resulting from a removal or placement, and so forth. The item recognition and transaction processing related to the merchandise items on the container unit(s) 202 may be transmitted from local computing device 204 to central server 206 over network 208 for billing, administrative, and inventory management/ordering purposes.

Network 208 may be any suitable type of network allowing transport of data communications across thereof. The network 208 may couple devices so that communications may be exchanged, such as between servers and client devices or other types of devices, including between wireless devices coupled via a wireless network, for example. Network 208 may also include mass storage, such as network attached storage (NAS), a storage area network (SAN), cloud computing and storage, or other forms of computer or machine readable media, for example. In one embodiment, the network may be the Internet, following known Internet protocols for data communication, or any other communication network, e.g., any local area network (LAN) or wide area network (WAN) connection, cellular network, wire-line type connections, wireless type connections, or any combination thereof. Communications and content stored and/or transmitted to and from central server 206 may be encrypted using, for example, the Advanced Encryption Standard (AES) with a 128, 192, or 256-bit key size, or any other encryption standard known in the art.

Servers, as described herein, may vary widely in configuration or capabilities but are comprised of at least a special-purpose digital computing device including at least one or more central processing units and memory. A server may also include one or more of mass storage devices, power supplies, wired or wireless network interfaces, input/output interfaces, and operating systems, such as Windows Server, Mac OS X, Unix, Linux, FreeBSD, or the like. In an example embodiment, a server may include or have access to memory for storing instructions or applications for the performance of various functions and a corresponding processor for executing stored instructions or applications. For example, the memory may store an instance of the server configured to operate in accordance with the disclosed embodiments.

FIGS. 3A through 3C present various views of a configuration of smart shelves according to an embodiment of the present invention. A smart shelf 302 may be configured with a container 300 as shown in the illustrated embodiment. Smart shelf 302 may include sensory hardware modules for capturing data. For example, smart shelf 302 may include static cameras and weight sensors. Given ones of the smart shelves may also include video cameras to monitor activity (e.g., physical interaction with items). A local computer or computing device may be coupled to the cameras and sensors for performing processing and analysis of data from the cameras and sensors. The local computer or computing device 306 may be located in a backroom, computing closet, or placed under, behind, or otherwise conspicuously placed at the container.

A container 300 (e.g., a refrigerator) may include a plurality of stacked smart shelves. The smart shelves may include weight sensors to determine a change in quantity of items that are stocked on the shelves. The weight sensors may comprise two strain gauge sensors placed on the smart shelf effectively transforming the shelf to a scale. A weight change from any item placed or removed from the smart shelf can be detected by the weight sensors. The weight sensors may also be used to determine a position an item was taken from or put in a smart shelf. The smart shelves may include mechanisms that allow for the shelves to operate in a flat mode or a tilted mode (where items can slide to the front based on gravity).

FIGS. 4A through 4C present detailed views of a smart shelf according to an embodiment of the present invention. One or more rear-facing static cameras 402 are configured on the smart shelf 302 to provide the ability to view and label (or identify) items placed on a shelf below. The smart shelf 302 may be situated above another smart shelf in the container 300. The rear-facing static cameras 402 may be placed under a frame or on the underbody of a shelf portion near or at the front of the container 300. The static cameras 402 may be pointed towards a rear of the container 300 and capture images of the immediate shelf below and its contents. A topmost shelf in the container 300 may include cameras placed above the shelf (or a dedicated shelf including cameras). The bottommost shelf of the container may not need cameras.

According to one embodiment, a container may include shelves designed with lanes having physical separators where items are placed along the lanes and movement of the items is confined within the lanes. For such containers, static cameras in the smart shelves may be placed at a position between the lanes such that each static camera can capture two lanes. For very deep containers, front-facing static cameras that are pointed toward the front of the container may also be placed on the smart shelves in a position near or at the back of the container. As an example, a container may include six lanes for each smart shelf and three static cameras per smart shelf with each camera placed in between two lanes such that the camera may capture items along the two lanes. In an alternative embodiment, the smart shelves may include mechanisms such as, a step motor, which allow for replacing the static cameras with a single camera per smart shelf. The mechanisms may move the camera along the front of a smart shelf such that the camera can take pictures of the entirety of the smart shelf. As such, the number of static cameras may be reduced per smart shelf.

The container 300 may further include a video camera module including video cameras that can be strategically placed to monitor items, for example, coming in or out of the container. The video camera module can be positioned to capture items outside of the container 300 as well as items that enter the smart shelves. An exemplary location of the video camera module may be on the top corner of the container 300. The video camera module may further include a communication module that allows it to feed a central unit or server with real-time video streams. The central unit or server may comprise a computing device including hardware such as, a central processing unit, memory, and graphics processing units, software, and cloud computing functionality for conducting machine learning, computer vision, probabilistic reasoning, and artificial intelligence processes to conduct item recognition and transaction processing related to items on the smart shelves.

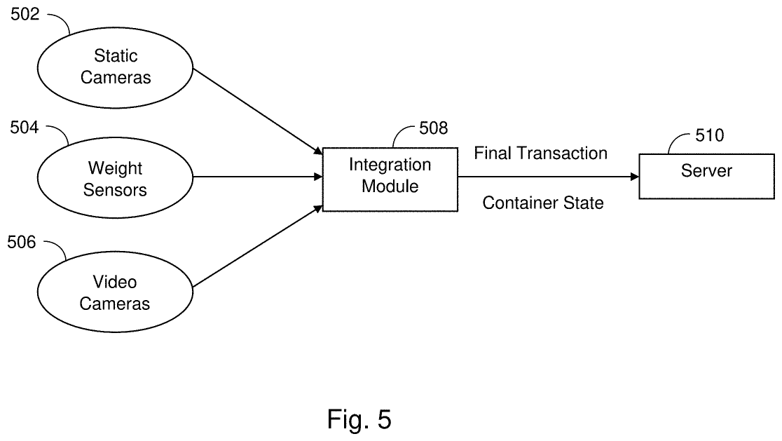

FIG. 5 presents a module system according to an embodiment of the present invention. The module system may include sensory modules including a static cameras module 502, a weight sensors module 504, and a video cameras module 506 that act independently and feed data input to an integration module 508. Modules, as described herewith, may include software logic, hardware, and/or a computing device configured to receive input data, process the input data, and generate output data from processing of the input data. The sensory modules may provide information regarding any change of items placed on a smart shelf. The data input received from the sensory modules may include information that can be used to track which items are in a container at all times. The combination of data from the static cameras module 502, weight sensors module 504, and video cameras module 506 may be resolved by the integration module 508 to corroborate events in the container. The resolved data can be used by the integration module 508 to secure and monitor what is taken from a container, what is put back in a container, and what is moved from one shelf to another within the container. The integration module 508 outputs final commercial transactions and container states to a server 510 based on the resolved data.

Static cameras module 502 may be configured to obtain images of inside a container to detect what is inside the container before and after a given session (e.g., detected interaction with the container by a user). If an action occurs and an item is moved out of a shelf position (or put back to a new shelf position) in the container, the static cameras module 502 may detect such an event. The static cameras module 502 may capture photos just before the start of a session (e.g., one photo per camera) and after the end of a session (e.g., one photo per camera). The static cameras module 502 may attempt to decide what has changed from the start of a session to the end of the session. Possible state configurations data of the smart shelves may be outputted from the static cameras module 502 to the integration module 508. The possible state configurations data based on the photos received by the static cameras module 502 may be corroborated with the other sensory modules by integration module 508. However, it is noted that the state configuration of an entire container (or all of the smart shelves) at the end of a session may be the same as the state configuration in the start of a next session. Thus, capturing only one photo per camera at the end of the session may reduce the data upload needed as well as data processing. The behavior of the static cameras module 502 is shelf invariant but may be trained or operated under different light conditions that could occur on any given shelf.

Video cameras module 506 may be configured to detect what leaves and enters a container. The video cameras module 506 may receive video recordings of the container by video cameras that start when a container is opened by the user and ends when the container is closed by the user. If an action occurs and an item is moved out of the container (even for a short period of time) the video cameras module 506 may capture and be used to detect such event. If the action occurs and the item is moved out of or put back to the container (even for a short period of time) the video cameras module 506 may also detect such events. The video cameras may be configured on a container to cover as many scenarios of, for example, hands bringing items in or out of the container. The video cameras module 506 may comprise a video processor or communicate data to a cloud platform that performs computer vision and machine learning methods to determine which items have been placed in and out of the containers and at what times. Data information of such are transmitted to integration module 508 which may also be corroborated with data from the other sensory modules by integration module 508.

The weight sensors module 504 can be applied and operated with any of smart shelves in a container to detect weight changes on the shelves during a session. The weight sensors module 504 may comprise strain gauge sensors on each shelf that provide data over time that permits computation of weight changes on any position of the shelf. Weight sensor measurements may occur during a session. Additionally, with an implementation of multiple strain gauge sensors on a shelf, rough position information of a weight change may be determined. If an item is removed from a location or placed in a location of a smart shelf, the weight sensors module 504 may report or detect such actions.

There are certain situations where the sensory modules, individually, are neither enough to provide accurate final commercial transaction for all situations that occur within a container nor provide accurate container state of each smart shelf. Static cameras module 502 may not be able to detect items that are occluded by other items. The static cameras modules 502 may also make mistakes of either mislabeling a detected item or detect items where there is none. The video cameras module 506 may not detect objects if they move in or out quickly (faster than frame rates) or multiple objects are moved out together and one hides the other or if hands and body cover an item during this process. Also mistakes can be made of either mislabeling a detected item or detect items where there is none. The weight sensors module 504 may not be able distinguish two different items that weigh the same. For example, if one replaces a non-valuable item with a legitimate item of value, when both have the same weight, the weight sensors module 504 may not distinguish such a scenario. Additionally, conflicts may exist between the modules where a correct final result may not be always reached.

As such, an integration module 508 is disclosed for acting as a sensor fusion module. The integration module 508 may take as input the output of the static cameras module 502, a weight sensors module 504, and video cameras module 506 as well as a current container state and utilizes, for example, probabilistic reasoning methods and/or machine learning methods to output a new container state and a final commercial transaction after the given session to server 510. Exemplary scenarios are used to describe exemplary functionality of the integration module.

In a first scenario, a case of very similar items is considered. In some instances, similar items may have small differences hidden to static cameras and may cause mistaken labels. In a session that happens to be particularly quick, the static cameras module 502 may infer that an item was removed and a new item was put back, when in fact the item was mislabeled by the static cameras module 502. The weight sensors module 504 may detect no change of weight, as the session was quick, that could be explained by the removal and placement of another (very similar) item very quickly. Clearly, a more likely scenario is that no item was removed, but requires confirmation.

This may be resolved by analyzing all of the information from the sensory modules as a whole. For example, data from the video cameras module 506 may identify that no item left the container. The video cameras module 506 may also detect differences between similar looking items, as long as the different features can be seen while being removed (and not covered by the hands). Alternatively, the video cameras module 506 may detect if an stock-keeping unit (“SKU”) did come in or did come out which would make it possible to determine if a similar item to the one detected could have come or not. Additionally, the weight sensors module may also report similar such information and where in the shelf such a change occurred or not. A processor or cloud computing functionality may gather all the information from the sensory modules from the integration module 508 (including the resolving data from the video cameras module 506) and determine that it is likely that such item mislabeled by the static cameras module 502 has the correct label assigned to the new container state. Therefore, the first scenario may be resolved correctly and the final transaction and update of the container state can be correct.

In a second scenario, due to occlusions, true negatives (undetected items) can occur for the static cameras module 502. For example, large/tall items in front of small items may be a source of occlusions for the static cameras module 502. In such instances, the static cameras module 502 may infer a (valuable) item was removed when in fact the item in the back moved so slightly to become occluded. Usage of probabilistic reasoning by a processor may assign a probability that a smaller item can hide behind a (presumably detected) larger item. In this case, the weight sensors module may not detect any weight change but may fall short in detecting that a decoy weight was placed behind a large item just to pick up the smaller valuable item.

However, this situation may be resolved by data from the video cameras module 506 that identifies that no item has left the container or, in the instance of bad intention behavior, it did leave (and replaced with a decoy). Moreover a video of such behavior exists from the video cameras module 506. The weight sensors module may also detect the presence of the hidden beverage by the weight. Thus, a conclusion may be made by the processor or cloud computing functionality using the integration component to determine that such item not detected by the static cameras module 502 should be accounted by the new container state. Or for bad intention behavior, that it indeed was removed. A probability of the occurrence of occlusion may also be computed based on the data from the weight sensors module and the video cameras module 506 to determine a correct final transaction and update the container state correctly.

By using a combination of the static cameras module 502, weight sensors module 504, and video cameras module 506, items in a container can be secured and resolved for certain situations where systems with, for example, just weight sensors, just video cameras, or just static cameras alone (or any two of the aforementioned) would not be suffice. One such situation includes invasors which are items that may be put in a container but do not belong in the container. For example, if a first brand provides a cooler to a vendor for selling items belonging to the first brand, other second brands may be considered as invasor items. The first brand will want to know if second brand items are being placed in the cooler they provided (e.g., this could be regardless of someone picking them up, and would be detected by a static camera). In another situation, an item that has been consumed and placed back in a container may also be considered as an invasor. For example, if someone puts back a bottle of water that is empty (in this case a weight sensor can detect this).

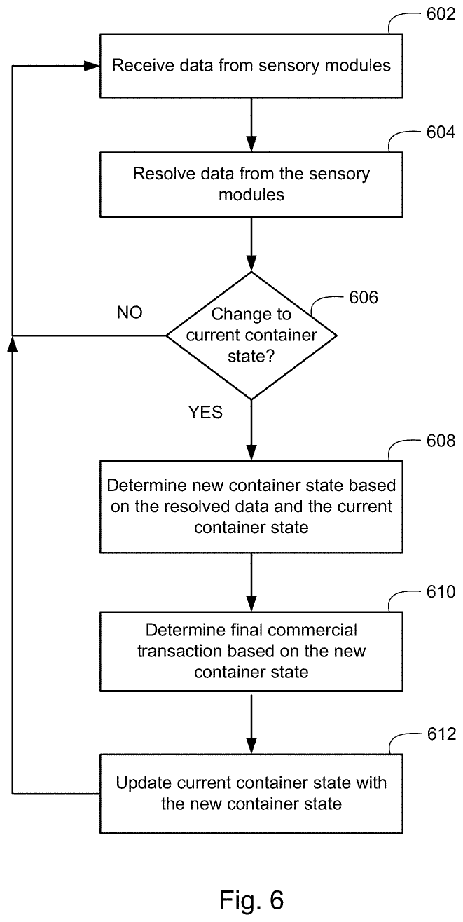

FIG. 6 illustrates a flowchart of a method for detecting a commercial transaction according to an embodiment of the present invention. Data is received, by a data processing system comprising a processor and a memory, from sensory modules of smart shelves within a container, step 602. The sensory modules may comprise a static cameras module, a weight sensors module, and a video cameras module that generate data output representative of physical activities and events corresponding to items on the smart shelves in a given session. The data output generated from individual ones of the sensory modules may include data representative of physical activities and events corresponding to the items.

The data from the sensory modules is resolved via an integration module, step 604. The data and any conflicting data associated with the physical activities and events corresponding to the items may be resolved by the integration module analyzing the data from the sensory modules as a whole and utilizing, for example, probabilistic reasoning methods and/or machine learning methods.

The data processing system detects whether a change to a current container state has occurred, step 606. If not, the data processing system returns to step 602 to receive data from the sensory modules. Otherwise, a change to the current container state causes the data processing system to determine a new container state after the given session based on the resolved data and the current container state, step 608. The current container state may comprise data identifying available inventory and placement of the inventory in the container prior to the detected change to the current container state. The resolved data may be used to determine a change to the available inventory and/or placement of the inventory. Based on the determined change to the available inventory and/or placement of the inventory, the new container state is determined including data identifying a new inventory and placement of the inventory in the container.

A final commercial transaction is determined based on the new container state, step 610. The final commercial transaction may comprise data including a description of which merchandise items have been taken from the container by a user and an indication that the taken merchandise items are desired to be purchased. The current container state is updated with the new container state, step 612 and then the data processing system returns to step 602.

FIGS. 1 through 6 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps). In software implementations, computer software (e.g., programs or other instructions) and/or data is stored on a machine-readable medium as part of a computer program product and is loaded into a computer system or other device or machine via a removable storage drive, hard drive, or communications interface. Computer programs (also called computer control logic or computer-readable program code) are stored in a main and/or secondary memory, and executed by one or more processors (controllers, or the like) to cause the one or more processors to perform the functions of the invention as described herein. In this document, the terms “machine readable medium,” “computer-readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

What is claimed is:

1. A system for detecting a commercial transaction through physical interactions with items, the system comprising:
a plurality of sensory modules associated with one or more shelves within a container, the plurality of sensory modules including a static cameras module, a weight sensors module, and a video cameras module;
an integration module configured to:
receive data from the plurality of sensory modules, the data including physical activities corresponding to items on the smart shelves in a given session;
resolve the data from the sensory modules using probabalistic reasoning and machine learning;
determine a new container state after the given session based on the resolved data; and
determine a final commercial transaction based on the new container state.

2. The system of claim 1 wherein the static cameras module is configured to:
retrieve images of inside the container before the given session and images of inside the container after the given session;
determine state configurations of the one or more smart shelves; and
transmit the state configurations to the integration module.

3. The system of claim 1 wherein the video cameras module is configured to:
receive video recordings that start when the container is opened and ends when the container is closed;
determine items that have been placed in and out of the container and times of which the items have been placed in and out of the container; and
transmit associated with the determined items and times to the integration module.

4. The system of claim 1 wherein the weight sensors module is configured to detect weight changes on the one or more shelves during the given session.

5. The system of claim 1 wherein the integration module is further configured to resolve the static camera module detecting an item removal by confirming with data from the video cameras module and the weight sensors module.

6. A method, in a data processing system comprising a processor and a memory, for detecting a commercial transaction through physical interactions with items, the method comprising:
receiving, by a computing device, data from a plurality of sensory modules associated with one or more shelves within a container, the plurality of sensory modules including a static cameras module, a weight sensors module, and a video cameras module, wherein the data includes physical activities corresponding to items on the smart shelves in a given session;
resolving, by the computing device, the data from the sensory modules using probabilistic reasoning and machine learning;
determining, by the computing device, a new container state after the given session based on the resolved data; and
determining, by the computing device, a final commercial transaction based on the new container state.

7. The method of claim 6 further comprising detecting a change to a current container state has occurred.

8. The method of claim 7 wherein the current container state comprises data identifying available inventory and placement of the inventory in the container prior to the detected change to the current container state.

9. The method of claim 8 wherein determining the new container state further comprises determining the new container state based a change to the available inventory or placement of the inventory.

10. The method of claim 6 wherein the final commercial transaction comprises data including a description of which items have been taken from the container and an indication that the taken items are desired to be purchased.

11. Non-transitory computer-readable media comprising program code that when executed by a programmable processor causes execution of a method for detecting a commercial transaction through physical interactions with items, the computer-readable media comprising:
computer program code for receiving data from a plurality of sensory modules associated with one or more shelves within a container, the plurality of sensory modules including a static cameras module, a weight sensors module, and a video cameras module, wherein the data includes physical activities corresponding to items on the smart shelves in a given session;
computer program code for resolving the data from the sensory modules using probabilistic reasoning and machine learning;
computer program code for determining a new container state after the given session based on the resolved data; and
computer program code for determining a final commercial transaction based on the new container state.

12. The non-transitory computer-readable media of claim 11 further comprising computer program code for detecting a change to a current container state has occurred.

13. The non-transitory computer-readable media of claim 12 wherein the current container state comprises data identifying available inventory and placement of the inventory in the container prior to the detected change to the current container state.

14. The non-transitory computer-readable media of claim 13 wherein the computer program code for determining the new container state further comprises computer program code for determining the new container state based a change to the available inventory or placement of the inventory.

15. The non-transitory computer-readable media of claim 12 wherein the final commercial transaction comprises data including a description of which items have been taken from the container and an indication that the taken items are desired to be purchased.
